(19) United States
(12) Patent Application Publication
(10) Pub. No.: US 2013/0100808 A1
(43) Pub. Date: Apr. 25, 2013

(54) Managing Utilization Of A Logical Communication Path In A Multi-Path Channel

(71) Applicants: Tal DORON, Haifa (IL); Eli MALUL, Tirat HaCarmel (IL); Eran MANN, Yoqneam (IL)

(72) Inventors: Tal DORON, Haifa (IL); Eli MALUL, Tirat HaCarmel (IL); Eran MANN, Yoqneam (IL)

(73) Assignee: KAMINARIO TECHNOLOGIES LTD., Yokne'am ILIT (IL)

(21) Appl. No.: 13/279,406

(22) Filed: Oct. 24, 2011

(51) Int. Cl. H04L 12/26

(52) U.S. Cl. 370/235

(57) ABSTRACT

A method of managing utilization of a logical communication path in a multi-path channel consisting of a plurality of logical communication paths overlying a plurality of physical connections connecting a first and a second node, including: for a non-ordered communication stream implementing a load-balancing communication mode to distributedly communicate messages of the non-ordered communication stream over the plurality of logical paths; and for an ordered communication stream implementing a designated logical path mode including designating a logical path of the multiple-path channel for communicating thereover messages of the ordered communication stream.

### FIELD OF THE INVENTION

The present invention is in the field of communication channel management.

### BACKGROUND

Available communication solutions perform load-balancing at the communication layer without providing reliability (e.g. Ethernet Link Aggregation—802.3ad). Other solutions provide reliable load-balancing at the application layer (e.g. SCSI multipath).

### SUMMARY OF THE INVENTION

Many of the functional components of the presently disclosed subject matter can be implemented in various forms, for example, as hardware circuits comprising custom VLSI circuits or gate arrays, or the like, as programmable hardware devices such as FPGAs or the like, or as a software program code stored on an intangible computer readable medium and executable by various processors, and any combination thereof. A specific component of the presently disclosed subject matter can be formed by one particular segment of software code, or by a plurality of segments, which can be joined together and collectively act or behave according to the presently disclosed limitations attributed to the respective component. For example, the component can be distributed over several code segments such as objects, procedures, and functions, and can originate from several programs or program files which operate in conjunction to provide the presently disclosed component.

In a similar manner, a presently disclosed component(s) can be embodied in operational data or operation data can be used by a presently disclosed component(s). By way of example, such operational data can be stored on a tangible computer readable medium. The operational data can be a single data set, or it can be an aggregation of data stored at different locations, on different network nodes or on different storage devices.

The method or apparatus according to the subject matter of the present application can have features of different aspects described above or below, or their equivalents, in any combination thereof, which can also be combined with any feature or features of the method or apparatus described in the Detailed Description presented below, or their equivalents.

Examples of the presently disclosed subject matter relate to a method and a device for managing a utilization of a logical communication path in a multi-path channel consisting of a plurality of logical communication paths overlying a plurality of physical connections connecting a first and a second node. According to examples of the presently disclosed subject matter, the method can include: for a non-ordered communication stream implementing a load-balancing communication mode, including distributedly communicating messages of the non-ordered communication stream over the plurality of logical paths; for an ordered communication stream implementing a designated logical path mode including designating a logical path of the multiple-path channel for communicating thereover messages of the ordered communication stream.

According to examples of the presently disclosed subject matter, the method can further include utilizing a reliable transport protocol to communicate message over physical paths underlying the multi-path channel, and wherein the logical path that is assigned to the ordered communication stream is utilized for communicating messages of the ordered communication stream multiplexed with messages of a non-ordered communication stream.

According to examples of the presently disclosed subject matter, the method can further include selecting a logical path that is to be assigned for a given non-ordered message from amongst the plurality of logical paths for communicating the message over the multi-path channel according to a current load on each of the plurality of logical paths.

According to examples of the presently disclosed subject matter, the method can further include: for a message that pertains to an ordered communication stream, determining which logical path is assigned to the respective ordered stream and communicating the message over the assigned logical path.

According to examples of the presently disclosed subject matter, the method can further include: for a given logical path overlying a first active physical connection connecting the first and a second node, implementing a first sequence for referencing messages communicated from the first node to the second node and implementing a second sequence for referencing messages communicated from the second node to the first node; attaching to a message communicated from the second node to the first node over the logical path, a current reference from the second sequence; upon receiving the message from the second node to the first node recording the current reference from the second sequence as the last received reference from the second sequence; and attaching to a message communicated from the first node to the second node over the logical path, a current reference from the first sequence and a last received reference from the second sequence.

According to examples of the presently disclosed subject matter, the logical path can overlie an active physical connection and at least one standby physical connection, and wherein the active physical connection and each one of the standby physical connections can be associated with a different physical path.

According to examples of the presently disclosed subject matter, the method can further include: detecting a failure of the active physical connection; obtaining from the first node the last received second sequence reference; designating a standby physical connection that is allocated to the logical path as an active physical connection instead of the failed physical connection; and communicating over the newly designated active physical connection from the second node to the first node messages that were communicated from the second node and whose second sequence reference is above the last received second sequence from the first node.

According to a further aspect of the presently disclosed subject matter there is provided a device for managing a utilization of a logical communication path in a multi-path channel consisting of a plurality of logical communication paths overlying a plurality of physical connections connecting a first and a second node. According to some examples of the presently disclosed subject matter, the device can include: a mode controller, a logical path designator and a load balancer. According to examples of the presently disclosed subject matter, wherein for a given communication that is to be communicated from the first node to the second node over the multi-path channel, the mode controller can be adapted to assign the message to the load-balancer if it is determined that the message is associated with a non-ordered communication stream, and the mode controller can be adapted to assign the message to the logical path designator if it is determined that the message is associated with an ordered communication.

Further according to examples of the presently disclosed subject matter, in case a logical path has already been assigned to the ordered communication stream with which the message is associated, the logical path designator can be adapted to cause the message to be communicated over the logical path which was assigned to the ordered communication stream with which the message is associated.

Still further according to examples of the presently disclosed subject matter, in case the message is the first message of an ordered communication stream that is handled by the device, the logical path designator can be configured to assign a logical path to the ordered communication stream and to record an indication with regard to the assignment of the logical path to the respective ordered communication stream.

According to examples of the presently disclosed subject matter, the device can further include a communication interface that is configured to utilize a reliable transport protocol to communicate messages over physical paths underlying the multi-path channel, and wherein the logical path that is assigned to the ordered communication stream can be utilized for communicating messages of the ordered communication stream multiplexed with messages of a non-ordered communication stream.

According to further examples of the presently disclosed subject matter, the load balancer can be adapted to select a logical path from amongst the plurality of logical paths that is to be assigned for a given non-ordered message, for communicating the message over the multi-path channel, according to a current load on each of the plurality of logical paths.

According to examples of the presently disclosed subject matter, the device can be associated with the first node and can further include a logical path controller that is associated with a given logical path of the multi-path channel, and wherein the logical path controller can include: an outbound sequence registry that is configured for referencing each message communicated from the first node to the second node over the logical path with which the respective logical path controller is associated; and an inbound sequence registry that is configured to record a reference of a most recently received message from the second node, wherein the reference in the inbound sequence registry corresponds to a reference of an outbound sequence registry associated with the second node.

According to examples of the presently disclosed subject matter, the logical path controller can be configured to attach or include with each message that is to be communicated over the respective logical path, a current reference from the outbound sequence registry and a current reference from the inbound sequence registry.

According to examples of the presently disclosed subject matter, the logical path overlies an active physical connection and at least one standby physical connection, and wherein the active physical connection and each one of the standby physical connections is associated with a different physical path.

Further according to examples of the presently disclosed subject matter, the logical path controller can further include: a physical connection monitor that can be configured to detect a failure of the active physical connection underlying the logical path; and a failover module that is responsive to an indication that the active physical connection has failed for: obtaining a current reference from the outbound sequence, designating a standby physical connection that is allocated to the logical path as an active physical connection instead of the failed physical connection, and wherein the logical path controller can be configured to cause the second node to communicate over the newly designated active physical connection to the first node messages that were transmitted from the second node to the first node but were not received at the first node.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic block diagram showing a plurality of network nodes interconnected by a multi-path channel and implementing a software module, a computer service or a device for managing a multi-path channel, as part of examples of the presently disclosed subject matter;

FIG. 2 is a block diagram illustration of a device for managing a multi-path channel, according to examples of the presently disclosed subject matter;

FIG. 3 is a flowchart illustration of a method of managing a multi-path channel, according to examples of the presently disclosed subject matter;

FIG. 4 is a simplified schematic illustration of two sequences of message communication over two physical paths of a multi-path channel, according to examples of the presently disclosed subject matter; and

FIG. 5 is a flowchart illustration of a failover process which can be implemented as part of a method of managing a multi-path channel, according to examples of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures and components have not been described in detail so as not to obscure the presently disclosed subject matter.

Unless specifically stated otherwise, as apparent from the following discussions, it is appreciated that throughout the specification discussions various functional terms refer to the action and/or processes of a computer or computing device, or similar electronic computing device, that manipulate and/or transform data represented as physical, such as electronic, quantities within the computing device's registers and/or memories into other data similarly represented as physical quantities within the computing device's memories, registers or other such tangible information storage, transmission or display devices.

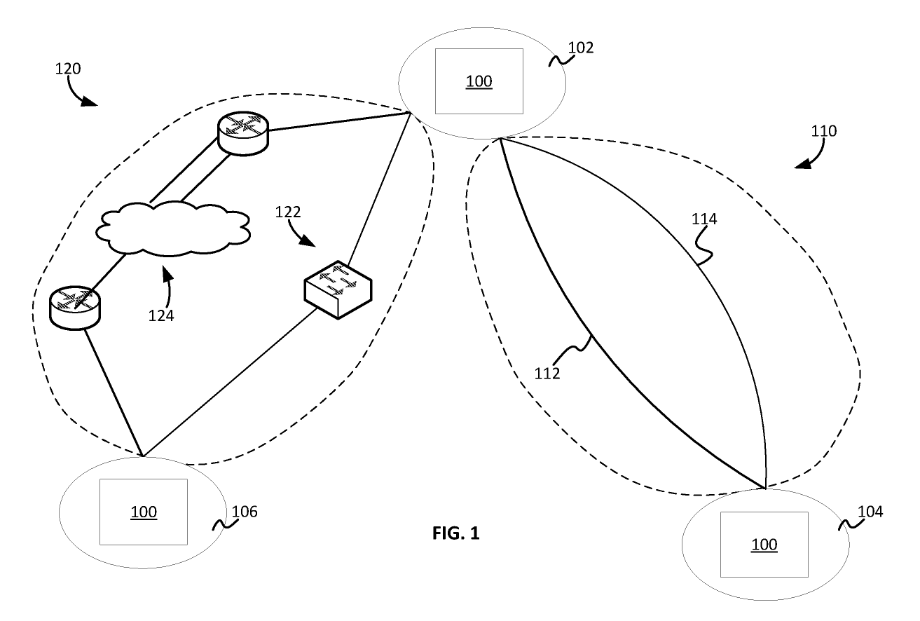

Reference is now made to FIG. 1, which is a schematic block diagram showing a plurality of network nodes interconnected by a multi-path channel and implementing a software module, a computer service or a device for managing a multi-path channel, as part of examples of the presently disclosed subject matter. As is shown in FIG. 1, a multi-path channel 110 is provided for interconnecting nodes 102 and 104. Similarly, multi-path channel 120 interconnects nodes 102 and 106. Many of the teachings provided herein with reference to multi-path channel 110 are applicable also to any other multi-path channel that is managed and controlled according to examples of the presently disclosed subject matter. Some particular features of examples of the presently disclosed subject matter are described with reference to the particular configuration of multi-path channel 120. Yet further features of examples of the presently disclosed subject matter are described with reference to node 102, which utilizes two multi-path channels, each for communicating with a different node, according to examples of the presently disclosed subject matter. According to further examples of the presently disclosed subject matter, the multi-path channel connects two virtual nodes that reside on the same hardware implementing a virtualization program.

According to examples of the presently disclosed subject matter, each of the nodes 102, 104 and 106 that share a multi-path channel 110 and 120, can implement a software module, a computer service or a device for managing a multi-path channel 100. Further by way of example, each one of nodes 104 and 106 can have one active instance of the software module, service or device 100, or each one of nodes 104 and 106 can instantiate one instance of the software module or service 100. For convenience, block 100 shall be generally described hereinforth as relating to a software module for managing a multi-path channel, but any such reference is meant to relate also to a corresponding device implemented in hardware, possibly in combination with software, or to a corresponding computer service.

According to examples of the presently disclosed subject matter, node 102 shares a multi-path channel 110 and 120 with each one of node 104 and 106, respectively. Accordingly, node 102 implements two instances of the software module for managing a multi-path channel 100, one for each multi-path channel 110 and 120. It would be appreciated that according to examples of the presently disclosed subject matter, a certain node can implement a plurality of instances of the software module for managing a multi-path channel 100 (e.g., two, three or more) in connection with a respective plurality of multi-path connections with other nodes. In further examples of the presently disclosed subject matter, two nodes can have two or more multi-path channel connections which connect the two nodes and can implement two or more respective instances of the software module for managing a multi-path channel 100. Further by way of example, a single software program or process on one node can utilize two or more multi-path channel connections for different types of communication required by the software program, for example, for different uses.

According to examples of the presently disclosed subject matter, each multi-path channel between two nodes is defined over two or more physical paths connecting the respective nodes. For example, multi-path channel 110 is defined over physical paths 112 and 114, which interconnect node 102 and 104. The term “physical path” as used herein relates to any physical network element or a combination of physical network elements that interconnect two nodes. Each one of any two different physical paths is characterized by a distinct physical network element or by a distinct combination of physical network elements. According to further examples of the presently disclosed subject matter, any physical network element that is associated with a physical path (possibly as part of a combination of physical elements that constitute the physical path) is uniquely associated with that physical path, and is not associated with any one of the other physical paths (in a multi-path channel). Further examples of physical paths are shown in FIG. 1, where physical path 122 extends across a switch (or switches), and where physical path 124 extends across routers and a network cloud. It would be appreciated that other configurations of physical paths can exist and that the proposed examples of the presently disclosed subject matter can be implemented with respect to such other physical path configurations. It would also be appreciated that while the multi-path channel configurations shown in FIG. 1 include two physical paths, other implementations of a multi-path channel according to further examples of the presently disclosed subject matter can include three or more physical paths.

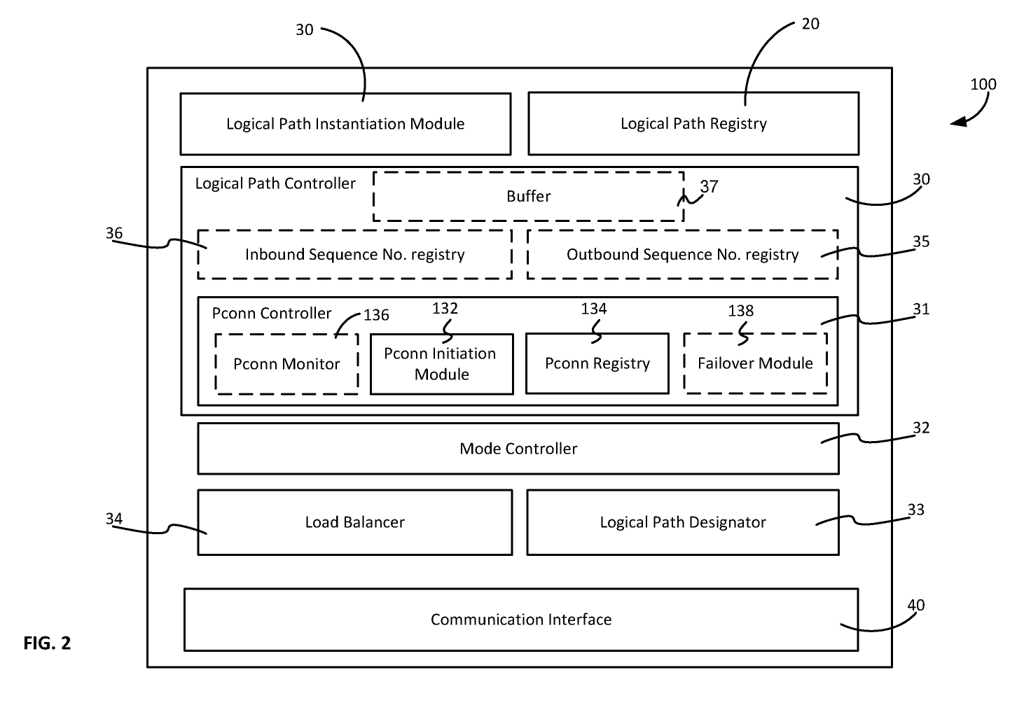

Reference is now additionally made to FIG. 2, which is a block diagram illustration of a device for managing a multi-path channel, according to examples of the presently disclosed subject matter. As mentioned above, the components shown in the block diagram in FIG. 2 can be implemented as one or more corresponding software modules or one or more services of a computer program (e.g., an operating system service), and the reference made to a device is made by way of example. According to examples of the presently disclosed subject matter, a software module for managing a multi-path channel 100 can include a logical path instantiation module 10, a logical path registry module 20, a logical path controller 30 and a communication interface 40.

According to examples of the presently disclosed subject matter, the logical path instantiation module 10 can be adapted to instantiate a plurality of logical communication paths over the plurality of physical paths 112 and 114 connecting the respective nodes 102 and 104. The term “logical path” as used herein defines a logical (or virtual) entity that is associated with one or more physical paths that connect a first and a second node. Further by way of example, a given logical path can be associated with two different physical paths that connect a first and a second node, as will be further described below.

According to examples of the presently disclosed subject matter, the logical path instantiation module 10 can be adapted to instantiate at least one logical communication path for a given physical path connecting the two respective nodes. Still further by way of example, the logical path instantiation module 10 can be adapted to instantiate at least two logical communication paths for a given multi-path channel 110.

According to further examples of the presently disclosed subject matter, each one of the logical paths can be registered in the logical path registry module 20. By way of example, the logical path registry for a given logical communication path can include data with respect to the physical path(s) over which the respective logical path is defined.

According to examples of the presently disclosed subject matter, the logical path controller 30 can be configured to control various aspects of the operation of each one of the logical communication paths. Further by way of example, the logical path controller 30 can include a physical connection controller 31 that is adapted to establish one or more physical connections for each one of the logical paths. The term “physical connection” as used herein relates to a network connection between two nodes. Each physical connection is initiated over a physical path that was assigned to the physical connection. In this regard, it would be appreciated that the physical connection controller 31 can be adapted to initiate an end-to-end physical connection that will be used to communicate messages that originate from a node at one end of the physical connection and are addressed to a node at the other end of the physical connection. Example of a source and of a destination of the messages according to examples of the presently disclosed subject matter is discussed below.

According to examples of the presently disclosed subject matter, the physical connection controller 31 can include a physical connection initiation module 132. The physical connection initiation module 132 can be adapted to initiate physical connections for the respective multi-path channel. Further by way of example, the physical connection initiation module 132 can be configured to receive as input a specification of the physical paths over which the multipath channel is defined and the physical connection initiation module 132 can be adapted to initiate one or more physical connections for each logical path, wherein each one of the physical connections are initiated over a physical path that was assigned to the physical connection. It would be appreciated that according to examples of the presently disclosed subject matter, more than one (e.g., two, three, etc.) physical connections can be initiated over a given (single) physical path.

By way of non-limiting example, the specification of the physical paths over which the multipath channel is defined can include a combination of a host address and a port address within that host, or any other equivalent address. The host-port addresses define the physical paths over which the multipath channel is defined. The logical path is a virtual entity (a software object) and it can be specified by reference.

According to examples of the presently disclosed subject matter, the physical connection initiation module 132 can be configured to establish a physical connection over a given physical path using a reliable transport protocol. Further by way of example, the physical connection initiation module 132 can be configured to establish a TCP physical connection over a given physical path. Other examples, of reliable transport protocol which can be used to establish a physical connection over a given physical path and for a given logical path can include, but are not limited to, the following: Infiniband using Reliable Connection Queue-Pair. It would be appreciated that the connection itself can be established outside the software module 100, for example, by an operating system with which the software module 100 is associated. For example, the connection itself can be established by an operating system of the computer which is running the software module 100, according to instructions from the physical connection initiation module 132.

An example of a physical connection initiation is now provided with reference to the multi-path channel 110 in FIG. 1. The physical connection initiation module 132 can be configured to initiate two physical connections for each one of two logical paths that have been instantiated for the multi-path channel 110. A first physical connection of a first logical path can be initiated over physical path 112, and a second physical connection of a first logical path can be initiated over physical path 114; and first physical connection of a second logical path can be initiated over physical path 114, and a second physical connection of a second logical path can be initiated over physical path 112.

According to examples of the presently disclosed subject matter, the physical connection controller 31 is further adapted to designate for each logical path an active, or a primary, physical connection. Further by way of example, if more than one physical connection is initiated for a given logical path, the physical connection controller 31 can be configured to designate the remaining physical connections (after designated one of the physical connections as the active physical connection) as standby, or secondary, physical connections.

According to examples of the presently disclosed subject matter, the physical connection controller 31 can include a physical connection registry 134 that is configured to register the initiated physical connections and data with respect to each one of the initiated physical connections. For example, the physical connection registry 134 can be configured to record in association with each one of the registered (and initiated) physical connections the underlying physical path and the logical path with which it is associated, and further in association with each one of the registered (and initiated) physical connections recorded in the physical connection registry 134 can record an indication with respect to the respective physical connection's status (active/primary or standby/secondary).

Having described an example initiation procedure and a network configuration over which a method of or a device for managing a multi-path channel can operate, there are now provided examples of an operation procedure according to which a method of managing a multi-path channel can operate. The method of managing a multi-path channel can be implemented by a multi-path channel management software module. For example, the method of managing a multi-path channel can be implemented by the multi-path channel management software module shown in FIG. 1. However, it would be further appreciated that the method of managing a multi-path channel can be implemented in corresponding hardware or in combination of hardware and software.

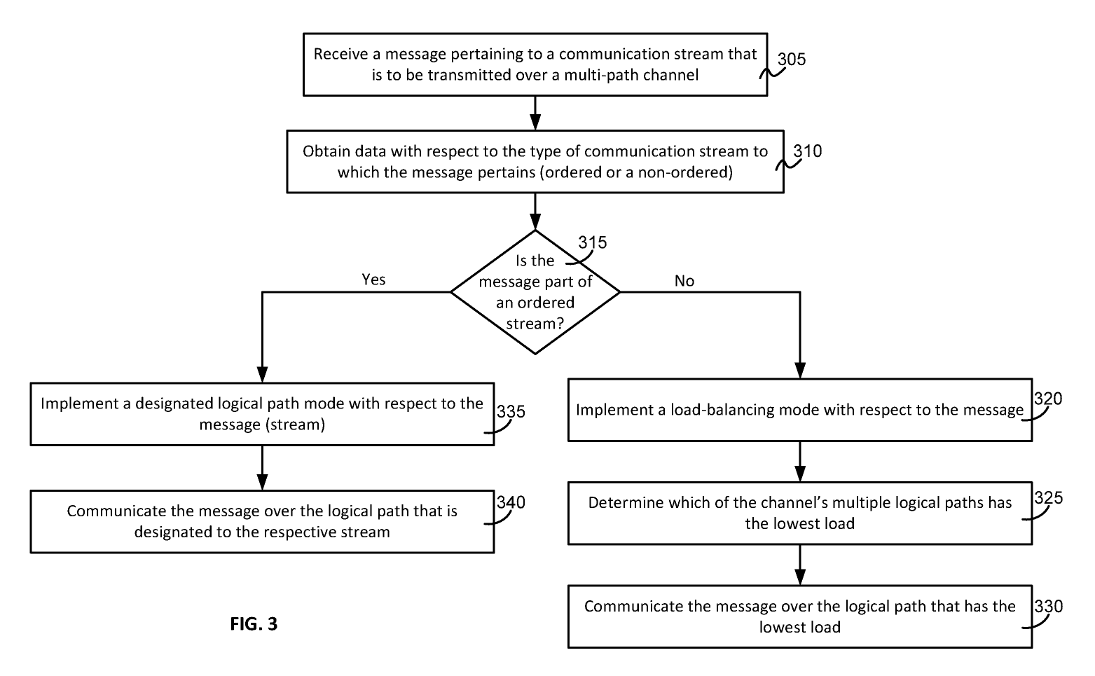

Reference is now additionally made to FIG. 3, which is a flowchart illustration of a method of managing a multi-path channel, according to examples of the presently disclosed subject matter. According to examples of the presently disclosed subject matter, a message pertaining to a communication stream that is to be transmitted over the multi-path channel can be received (block 305) at the software module 100. By way of example, the multi-path channel management software module 100 can include an interface module 40 through which the messages are received from an application or a service running on a computer on which the software module 100 is running.

Still further by way of example, the multi-path channel management software module 100 can be integrated with a main software application, and the main software application or some other module thereof can be configured to instantiate the multi-path management software module 100 to enable and manage communications over the respective multi-path channel with an application or a process running on a node at the other end of the multi-path channel. Still further by way of example, the main software application, or some other module thereof, can be configured to generate messages and/or streams of messages that are addressed to a destination node at the other end of a multi-path channel, and the multi-path channel management software module 100 can be utilized to handle and control communication of the messages over the multi-path channel, as described below.

It would be appreciated that the software module or the service that is the source of the message that is to be transmitted over the multi-path channel can be implemented on a separate computer and can be communicated to the software module 100, to thereby cause the message to be communicated over the respective multi-path channel to the node at the other end of the channel.

Examples of sources of messages which can be provided as input to the software module 100, and which can be communicated over the multi-path channel to the node at the other end of the channel include, but are not limited to: a block storage service (issue READ, WRITE commands, etc.), remote procedure call service, etc.

According to examples of the presently disclosed subject matter, the multi-path channel management software module 100 maintains connections over (or enables to maintain) a multi-path channel between a first node and a second node, and thus by assigning a given message to a particular multi-path channel management software module 100 on a first node the source service implies to which destination the message is addressed (the second node).

Resuming now the description of FIG. 3, according to examples of the presently disclosed subject matter, at block 310, data with respect to the type of communication stream to which the message pertains (ordered or a non-ordered) can be obtained. According to examples of the presently disclosed subject matter, the multi-path channel management software module 100 can include, for example as part of the logical path controller 30, a mode controller 32, and the mode controller 32 can be configured to obtain, from each message that is addressed to the node at the other end of the multi-path channel, an ordering key. The mode controller 32 can be configured to determine, based on the ordering key that is included in or associated with the message, whether the message is part of an ordered stream or whether the message is part of a non-ordered stream. Further by way of example, instead of an ordering key an ordering flag can be used, and at the “on” state (for example) the flag can indicate that the message is part of an ordered stream and at the “off” state the flag can indicate that the message is not part of an ordered stream. Other known indications can also be used.

In a further example of the presently disclosed subject matter, once a new stream is initiated, a type indicator, e.g., ordered or non-ordered, can be provided to the mode controller 32, for example by a stream initiation message, which is received as the first message of a given stream, following the initiation of the stream. The mode controller 32 can be configured to register the stream, for example, using the stream identifier, and in association with the record for the stream, the mode controller 32 can register the stream type, e.g. ordered or non-ordered. Each message that pertains to a given stream can include the identifier of the stream to which it pertains, for example in a header of the message, and the mode controller 32 can read from the stream registry the type of stream to which the message pertains according to the provided stream identifier.

Once the data with regard to the stream type is obtained (either from each individual message or by determining to which stream the message pertains and according to the type indication stored for the stream to which the message pertains), the mode controller 32 can be configured to determine whether the message is part of an ordered stream or part of a non-ordered stream (block 315).

According to examples of the presently disclosed subject matter, in case at block 315 it is determined that the message is part of a non-ordered communication stream the mode controller 32 can be configured to implement a load-balancing mode with respect to the message (block 320). According to examples of the presently disclosed subject matter, in the load-balancing mode, the message is fed or otherwise assigned to a load balancing module 34 that is configured to select a logical path over to which the current message is assigned (block 325) according to a predefined criterion. Further according to examples of the presently disclosed subject matter, in the load balancing mode, different messages of a certain (non-ordered) communication stream can be assigned to different logical paths. According to still further examples, the criterion that is implemented by the logical path controller 30 to select a logical path to which a message which pertains to a non-ordered stream is to be assigned, is independent of the assignment (to one of the plurality of logical paths in the multi-path channel) of any previous message of the same communication stream.

As mentioned above, load balancing is used herein as one example of a criterion which can be used by the logical path controller 30 to select, for a given message that pertains to a non-ordered stream, the logical path over which the message is to be communicated to the destination node. It should be appreciated that further examples of the presently disclosed subject matter, are not limited to the use of a load balancing selection criterion, and that other selection criterion or criteria can be used, including arbitrary selection, round robin selection, etc. It should be further appreciated that according to some examples of the presently disclosed subject matter, the selection criterion implemented by the logical path controller 30 for selecting, for a given message which pertains to a non-ordered stream, a logical path over which the message is to be communicated to the destination node can be configured to take into account certain operational parameters, including for example, parameters relating to the operation or state of the multi-path channel, of one or more of the logical paths, of one or more of the physical connections, of the software application or process from which the message originated, etc.

In the example illustrated in FIG. 3, in case the message is a non-ordered message, and is thus fed to the load-balancing module 34, the load-balancing module 34 can be configured to determine which one of the multiple logical paths of the multi-path channel currently has the lowest load, and can select the logical path that is currently the least loaded for communicating the current message thereover.

According to examples of the presently disclosed subject matter, following block 325 and the selection of a logical path to which the current message (which pertains to a non-ordered stream) is to be assigned, the message can be communicated using the physical connection with which the selected logical path is currently associated (block 330).

According to examples of the presently disclosed subject matter, in case at block 315 it is determined that the message is part of an ordered communication stream, the mode controller 32 can implement a designated logical path mode with respect to the message (block 335). According to examples of the presently disclosed subject matter, in the designated logical path mode, the message is fed or otherwise assigned to a logical path designator 33 that is configured to communicate the message over a logical path that was designated for communicating all the messages of the communication stream which the current message is part of, and the message is communicated over the designated logical path (block 340).

As mentioned above, according to some examples of the presently disclosed subject matter, the type designation that is used for determining whether a given message is part of an ordered or a non-ordered stream can be provided with each message (or in association with each message), or the type designation can be provided once for the stream to which the message pertains, and the corresponding communication mode can be determined for each message according to a stream identifier that is provided with each message (or in association with each message).

Thus, some examples of the presently disclosed subject matter can be used to provide a multi-path channel that combines load-balancing capabilities with logical path designation capabilities for communication streams that require maintaining the order of the stream's messages. By way of example, the combination of the load-balancing capabilities with logical path designation capabilities can enable substantially efficient utilization of the network resources between the two nodes connected by the multi-path channel, while providing support for in-order communication and receipt of messages that pertain to ordered communication streams.

Further according to examples of the presently disclosed subject matter, the ability to provide a multi-path channel that combines load-balancing capabilities with logical path designation capabilities can be achieved by a process that is implemented in the transport (communication) layer. Still further according to examples of the presently disclosed subject matter, the ability to provide a multi-path channel that combines load-balancing capabilities with logical path designation capabilities is achieved substantially without requiring processing in the application layer.

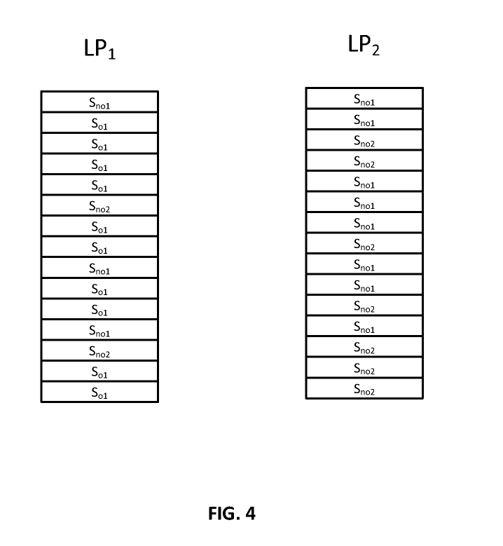

Reference is now made to FIG. 4 which is a simplified schematic illustration of two sequences of message communication over two physical paths of a multi-path channel, according to examples of the presently disclosed subject matter. In FIG. 4 the logical path marked with the annotation “LP₁” relate to a first logical path, the logical path marked with the annotation “LP₂” relate to a second logical path, the messages marked with the annotation “Sₒ₁” relate to an ordered stream, the messages marked with the annotation “Sₙₒ₁” relate to a first non-ordered stream, and the messages marked with the annotation “Sₙₒ₂” relate to a second non-ordered stream. As can be seen in FIG. 4, LP₁ was designated for communicating (all) the messages of the ordered communication stream Sₒ₁, and thus all the messages which pertain to Sₒ₁ are communicated through the multi-path channel over the logical path LP₁ which was designated for the ordered communication stream Sₒ₁, and are thus received in the order by which they were transmitted.

As can also be seen in FIG. 4, the messages of communication streams Sₙₒ₁ and Sₙₒ₂, which are both non-ordered communication streams, are communicated over more than one logical path. For example, the messages of the non-ordered streams Sₙₒ₁ and Sₙₒ₂ can be communicated over a plurality of logical paths of the multi-path channel (in this simplified example, over the two available logical paths LP₁ and LP₂).

As can be further seen in FIG. 4, according to examples of the presently disclosed subject matter, the messages from the non-ordered streams Sₙₒ₁ and Sₙₒ₂ can be multiplexed with messages from other streams, including messages from ordered streams and messages from other non-ordered streams, according to the messages assignment criteria that is implemented by the logical path controller 30. In this regard, it would be appreciated that according to examples of the presently disclosed subject matter, a logical path that was designated for communicating messages of a given ordered communication stream, e.g., LP₁, can be used to communicate messages from non-ordered streams which can be multiplexed with messages from the ordered stream to which the logical path was assigned. Similarly, a certain logical path can be designated for two or more different ordered communication streams.

There is now provided a description of further examples of the presently disclosed subject matter, wherein failover capabilities are added to the multi-path channel management. Referring back to FIG. 2, according to examples of the presently disclosed subject matter, the software module for managing a multi-path channel 100 can include an outbound sequence registry module 35, and inbound sequence registry module 36, a physical connection monitor 136 and a failover module 138. Further by way of non-limiting example, the physical connection monitor 136 and the failover module 138 can be implemented as part of the physical connection controller 31.

According to examples of the presently disclosed subject matter, as part of the failover process, for a given communication direction over a logical path of the multi-path channel, sequencing of messages exchanged between the nodes which are connected to one another by the multi-path channel, is implemented. Further by way of example, the sequencing of messages can be implemented for each communication direction of a given logical path of the multi-path channel, such that at each node both inbound and outbound sequences are used for each logical path connecting the first and second nodes. For example, referring to FIG. 1 for the multi-path channel marked 110 for each logical path, message sequencing can be implemented for each one of the communication directions, i.e., from node 102 to node 104 and from node 104 to node 102. Thus according to examples of the presently disclosed subject matter, the sequencing at a first node can include receiving a first message from a second node (over a logical path of a multi-path channel), the first message including or is associated with a first sequence number indicating the outgoing sequence number on the second node for this logical path (and the inbound sequence number on the first node). When communicating a subsequent second message from the first node to the second node (over the same logical path of the multi-path channel) attaching to the second message the first sequence number received from the second node (now an inbound sequence number) and further attaching to the message a second sequence number indicating the outbound sequence number on the first node.

It would be appreciated that according to examples of the presently disclosed subject matter, the sequencing of messages can be accomplished in any form, including by way of incrementing a numeral index, or using any other symbol to enumerate the messages. Further by way of example, a difference sequence can be provided for each one of the communication streams that are transmitted over each one of the respective logical paths.

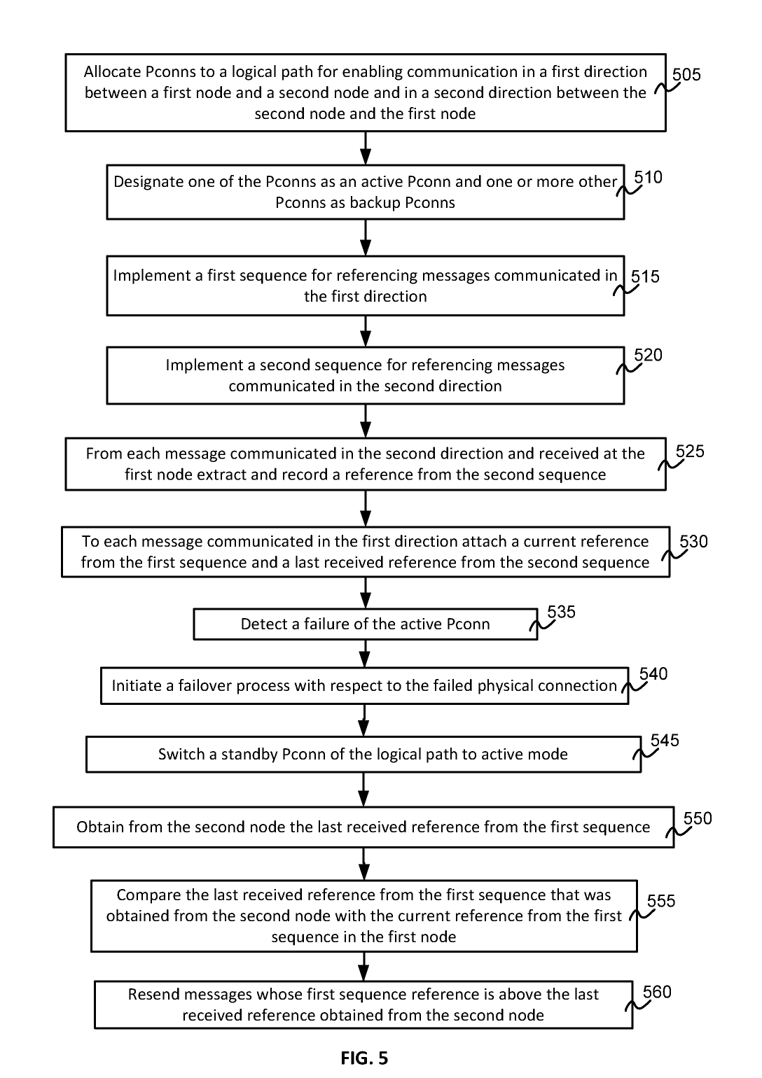

FIG. 5 to which reference is now made, is a flowchart illustration of a failover process which can be implemented as part of a method of managing a multi-path channel, according to examples of the presently disclosed subject matter. In case a failover process is implemented, according to examples of the presently disclosed subject matter, as part of the method of managing a multi-path channel, physical connections can be allocated to a logical path for enabling communication in a first direction between a first node, say node 102, and a second node, say node 104, and in a second direction between the second 104 node and the first node 102 (block 505).

Further according to examples of the presently disclosed subject matter, one of the physical connections allocated to the logical paths can be designated as an active physical connection and one or more other physical connections can be designated as a backup physical connection (block 510). Thus for example, referring to FIG. 1, from a certain logical path of the multi-path channel 110 two physical connections can be initiated over physical paths 112 and 114, and for this logical path, the physical connection associated with the physical 112 can be designated as the active physical connection for the given logical path and the physical connection associated with the physical 114 can be designated as the backup physical connection for the given logical path.

According to examples of the presently disclosed subject matter, a first sequence can be implemented for referencing messages communicated in the first direction of the logical path (block 515). For example, referring to the example of a multi-path channel 110 shown in FIG. 1, the first sequence can be implemented for referencing messages communicated from node 104 to node 102 of the logical path for which the active physical connection is associated with physical path 112. A second sequence can be implemented for referencing messages communicated in the second direction of the logical path (block 520). For example, for referencing messages communicated from node 102 to node 104 of the logical path for which the active physical connection is associated with physical path 112, a second sequence can be implemented.

According to examples of the presently disclosed subject matter, from each message that communicated in the second direction and was received at the first node, a reference from the second sequence (block 525) is extracted and recorded. For example, referring to the multi-path channel 110 shown in FIG. 1, and to the software module 100 shown in FIG. 2, a message from node 104 can be received at node 102, and from that message a sequence number referencing messages communicated in the direction from node 104 to 102 can be extracted and recorded on the first node 102, for example in an inbound sequence number registry 36 that can be implemented as part of logical path controller 30 of the software module 100 on the first node 102.

Further according to examples of the presently disclosed subject matter, to each message communicated in the first direction, attaching a current reference from the first sequence and a last received reference from the second sequence (block 530). Referring again to the multi-path channel 110 shown in FIG. 1, and to the software module 100 shown in FIG. 2, a message from node 102 to node 104 can include or be associated with each of a current sequence number from a first sequence, for example provided by an outbound sequence number registry 35 that can be implemented as part of logical path controller 30 of the software module 100 on the first node 102, the first sequence referencing messages communication in the direction from node 102 to 104, and the current sequence number indicating the current sequence number in the first sequence; and a last received reference from the second sequence, for example obtained from an inbound sequence number registry 36 that is implemented as part of logical path controller 30 of the software module 100 on the first node 102.

Thus, messages exchanged over the multi-path channel can carry a current outbound and last received (inbound) reference numbers from respective sequences, and the registries, e.g., 36 and 35 respectively, at each node of the multi-path channel can record the reference numbers. According to examples of the presently disclosed subject matter, at some point a physical path may fail. When a physical path fails, certain messages that have been already transmitted by one node, may not arrive at the other node.

The failover process, according to examples of the presently disclosed subject matter, can be implemented in order to enable recovery or at least message loss awareness in case messages are lost as a result of a failure of a physical path which underlies a physical connection and a corresponding logical path in a multi-path channel connection. In this regard, it would be appreciated that the transport layer provisions that are implemented by many standard protocols are not suitable for enabling recovery or even message loss awareness in case messages are lost as a result of a failure of a physical path which underlies a physical connection and a corresponding logical path in a multi-path channel connection.

Returning now to FIG. 5, at some point, for example, while messages are communicated over an active physical connection which underlies a logical path of a multi-path channel, a failure of the active physical connection can be detected (block 535). By way of example, the physical connection monitor 136 can be adapted to implement an error detection measure to identify a possible failure of an active physical connection. In further examples, the physical connection monitor 136 can possibly be adapted to also monitor a standby physical connection for a failure. Still further by way of example, failure detection can include monitoring notices from the operating system that are associated with messages communicated over a physical connection. As would be appreciated by those versed in the art, certain operating systems are configured to issues error messages in case a certain communication over a physical connection failed, such as in case of failure in sending or receiving a communication over a physical connection. Such operating system notifications can be identified, for example, by the physical connection monitor 136, and can trigger a failover operation or procedure. In further examples of the presently disclosed subject matter, failure detection can include sending heartbeat messages periodically over a physical connection, and monitoring, for example, using the physical connection monitor 136, the physical connection for returned heartbeats. Further by way of example, if no returned heartbeat is received over a certain period of time (e.g., several times the estimated heartbeat transmission period), the physical connection is regarded as failed and a failover routine is initiated.

It would be appreciated that a failure of a physical connection can occur for a variety of reasons, including but not limited to: failure of a network component along the physical path (e.g. a network interface, a network switch), and failure of a software component on one of the nodes connected by the physical connection.

According to examples of the presently disclosed subject matter, the multi-path management software module 100 can include, for example, as part of the physical connection controller 31, a physical connection monitor 136. Further by way of example, the physical connection monitor 136 can be configured to monitor the physical connection(s) of the multi-path channel, and can be adapted to detect a failure of one of the physical connections. Still further by way of example, the physical connection monitor 136 can be configured to monitor active physical connections, and to provide an indication when failure is detected with respect to an active or standby physical connection.

According to examples of the presently disclosed subject matter, when a failure is detected (block 535), a failover process can be initiated. For example, in case a failure of one of the active physical connections of the multi-path channel is detected by the physical connection monitor 136, the physical connection monitor 136 can alert failover module 138, thereby causing a failover process to be initiated with respect to the failed physical connection (block 540). As is shown in FIG. 2, the failover module can be implemented as part of the physical connection controller 31 of the multi-path management software module 100.

According to examples of the presently disclosed subject matter, as part of the failover process, the failover module 138 can be configured to switch a standby physical connection, that is assigned to the same logical path as the failed physical connection, to an active mode (block 545). Further as part of the failover process, the failover module 138 on one of the nodes that was connected to the failed physical connection (say node 102) can be adapted to obtain from one of the other nodes that was connected to the failed physical connection (say node 104) the last received reference from the node whereon the failover module 138 is implemented (node 102). In FIG. 5, continuing with the same references used in block 505 and 515-530, as part of a failover process, the failover module 138 on the first node can communicate with the second node, and can obtain from the second node the last received reference from the first sequence (block 550). The last received reference from the first sequence that is registered in the second node can indicate the last message from the first node that was successfully communicated to the second node, for example, over the physical connection, prior to failure of the physical connection.

According to examples of the presently disclosed subject matter, in order to communicate with the second node, the failover module 138 can use the physical connection that was activated as part of the failover process. In a further example, the failover module 138 can use any available physical connection for communicating with the second node as part of the failover process. According to examples of the presently disclosed subject matter, as part of the failover process, failover message can be exchanged between the affected nodes to allow the failover modules 138 to operate and perform the operations described herein.

Still further as part of the failover process, the failover module 138 can be adapted to obtain from the node on which it is implemented (node 102) the current reference in its outbound messages sequence. Using the terms used in FIG. 5, the failover module 138 can be adapted to obtain from the node on which it is implemented (node 102) the current reference from the first sequence. Next, the failover module can be adapted to compare the last received reference from the first sequence that was obtained from the second node with the current reference from the first sequence in the first node (block 555). The result of this comparison indicates which messages were sent from the first node but were not received by the second node, for example, as a result of the failure of the physical connection. It would be appreciated, that according to examples of the presently disclosed subject matter, the sequences can be associated with a given logical path, and the indication with regard to lost messages can relate to the logical path whose active physical connection has failed.

According to examples of the presently disclosed subject matter, once the failover module 138 determines which messages were lost as a result of the failure of the physical connection, the failover module 138 can be configured to cause the node on the first node to resend messages whose first sequence reference is above the last received reference obtained from the second node (block 560). In accordance to examples of the presently disclosed subject matter, the logical path controller 30 can include a buffer 37, and the buffer 37 can be utilized to store messages that were recently transmitted from the node on which the software module 100 is implemented and over the respective logical path, thus enabling the failover module 138 to obtain and resend messages that were lost due to a failure of a physical connection.

It would be appreciated that the process illustrated in FIG. 5, including the failover process, can be carried out at each end of the failed physical connection by the software module 100 implemented on each of the respective nodes. Thus, the communications over the multipath channel can be restored following a failure of a physical connection that is used by the multi-path channel.

According to examples of the presently disclosed subject matter, the communication between the two nodes on either side of the failed physical connection can be carried out over one of the other physical connections of the multi-path channel or can be carried out over any other physical connection that connects the two nodes.

It will also be understood that the device according to the invention can be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method of managing a utilization of a logical communication path in a multi-path channel consisting of a plurality of logical communication paths overlying a plurality of physical connections connecting a first and a second node, the method comprising:
for a non-ordered communication stream implementing a load-balancing communication mode, including distributedly communicating messages of the non-ordered communication stream over said plurality of logical paths;
for an ordered communication stream implementing a designated logical path mode including designating a logical path of said multiple-path channel for communicating thereover messages of the ordered communication stream.

2. The method according to claim 1, further utilizing a reliable transport protocol to communicate messages over physical paths underlying the multi-path channel, and wherein the logical path that is assigned to the ordered communication stream is utilized for communicating messages of the ordered communication stream multiplexed with messages of a non-ordered communication stream.

3. The method according to claim 1, further comprising selecting a logical path from amongst the plurality of logical paths that is to be assigned for a given non-ordered message for communicating the message over the multi-path channel according to a current load on each of the plurality of logical paths.

4. The method according to claim 1, further comprising: for a message that pertains to an ordered communication stream, determining which logical path is assigned to the respective ordered stream and communicating the message over the assigned logical path.

5. The method according to claim 1, further comprising
for a given logical path overlying a first active physical connection connecting the first and a second node, implementing a first sequence for referencing messages communicated from the first node to the second node and implementing a second sequence for referencing messages communicated from the second node to the first node;
attaching to a message communicated from the second node to the first node over the logical path a current reference from the second sequence;
upon receiving the message from the second node to the first node, recording the current reference from the second sequence as the last received reference from the second sequence; and
attaching to a message communicated from the first node to the second node over the logical path, a current reference from the first sequence and a last received reference from the second sequence.

6. The method according to claim 5, wherein the logical path overlies an active physical connection and at least one standby physical connection, and wherein the active physical connection and each one of the standby physical connections is associated with a different physical path.

7. The method according to claim 6, further comprising:
detecting a failure of the active physical connection;
obtaining from the first node the last received second sequence reference;
designating a standby physical connection that is allocated to the logical path as an active physical connection instead of the failed physical connection; and
communicating over the newly designated active physical connection from the second node to the first node messages that were communicated from the second node and whose second sequence reference is above the last received second sequence from the first node.

8. A device for managing a utilization of a logical communication path in a multi-path channel consisting of a plurality of logical communication paths overlying a plurality of physical connections connecting a first and a second node, the device comprising:
a mode controller;
a logical path designator; and
a load balancer,
wherein for a given communication that is to be communicated from the first node to the second node over the multi-path channel, said mode controller is adapted to assign a message to the load-balancer if it is determined that the message is associated with a non-ordered communication stream, and said mode controller is adapted to assign the message to the logical path designator if it is determined that the message is associated with an ordered communication.

9. The device according to claim 8, wherein in case a logical path has already been assigned to the ordered communication stream with which the message is associated, said logical path designator is adapted to cause the message to be communicated over the logical path which was assigned to the ordered communication stream with which the message is associated.

10. The device according to claim 8, wherein in case the message is the first message of an ordered communication stream that is handled by the device, said logical path designator is configured to assign a logical path to the ordered communication stream and to record an indication with regard to the assignment of the logical path to the respective ordered communication stream.

11. The device according to claim 8, wherein the device further includes a communication interface that is configured to utilize a reliable transport protocol to communicate message over physical paths underlying the multi-path channel, and wherein the logical path that is assigned to the ordered communication stream is utilized for communicating messages of the ordered communication stream multiplexed with messages of a non-ordered communication stream.

12. The device according to claim 8, wherein said load balancer is adapted to select a logical path from amongst the plurality of logical paths that is to be assigned for a given non-ordered message, for communicating the message over the multi-path channel, according to a current load on each of the plurality of logical paths.

13. The device according to claim 8, wherein the device is associated with the first node and further includes a logical path controller that is associated with a given logical path of the multi-path channel, and wherein the logical path controller includes:
an outbound sequence registry for referencing each message communicated from the first node to the second node over the logical path with which the respective logical path controller is associated; and
an inbound sequence registry that is configured to record a reference of a most recently received message from the second node, wherein the reference in the inbound sequence registry corresponds to a reference of an outbound sequence registry associated with the second node.

14. The device according to claim 13, wherein the logical path controller is configured to attach or include with each message that is to be communicated over the respective logical path, a current reference from the outbound sequence registry and a current reference from the inbound sequence registry.

15. The device according to claim 14, wherein the logical path overlies an active physical connection and at least one standby physical connection, and wherein the active physical connection and each one of the standby physical connections is associated with a different physical path.

16. The device according to claim 15, wherein the logical path controller further comprises:
a physical connection monitor that is configured to detect a failure of the active physical connection underlying the logical path; and
a failover module that is responsive to an indication that the active physical connection has failed for:
obtaining a current reference from the outbound sequence,
designating a standby physical connection that is allocated to the logical path as an active physical connection instead of the failed physical connection,
and wherein the logical path controller is configured to cause the second node to communicate over the newly designated active physical connection to the first node messages that were transmitted from the second node to the first node but were not received at the first node.

17. A program storage device readable by machine, tangibly embodying a program of instructions executable by the machine to perform a method of managing a utilization of a logical communication path in a multi-path channel consisting of a plurality of logical communication paths overlying a plurality of physical connections connecting a first and a second node, the method comprising:
for a non-ordered communication stream implementing a load-balancing communication mode, including distributedly communicating messages of the non-ordered communication stream over said plurality of logical paths;
for an ordered communication stream implementing a designated logical path mode including designating a logical path of said multiple-path channel for communicating thereover messages of the ordered communication stream.

18. A computer program product comprising a computer useable medium having computer readable program code embodied therein of managing a utilization of a logical communication path in a multi-path channel consisting of a plurality of logical communication paths overlying a plurality of physical connections connecting a first and a second node, the computer program product comprising:
computer readable program code for causing the computer to for a non-ordered communication stream implementing a load-balancing communication mode, including distributedly communicating messages of the non-ordered communication stream over said plurality of logical paths;
computer readable program code for causing the computer to, for an ordered communication stream, implement a designated logical path mode including designating a logical path of said multiple-path channel for communicating thereover messages of the ordered communication stream.
